(19) United States
(12) Patent Application Publication
(10) Pub. No.: US 2002/0135767 A1
(43) Pub. Date: Sep. 26, 2002

(54) Optical alignment element method

(76) Inventors: Jenkin A. Richard, Palo Alto, CA (US); Eric V. Chamness, Menlo Park, CA (US); David F. Moore, Redwood City, CA (US); Ryan D. Bruneau, Sunnyvale, CA (US); George H. Guan, Fremont, CA (US); Steven J. Benerofe, San Francisco, CA (US); Nader Mahvan, Cupertino, CA (US); Don Andre Clark, Berkeley, CA (US)

Correspondence Address: SAWYER LAW GROUP LLP, P O BOX 51418, PALO ALTO, CA, 94303, US

(21) Appl. No.: 09/916,624

(22) Filed: Jul. 27, 2001

Related U.S. Application Data
(60) Provisional application No. 60/276,639, filed on Mar. 16, 2001.
(60) Provisional application No. 60/276,636, filed on Mar. 16, 2001.

(51) Int. Cl. G01B 11/00

(52) U.S. Cl. 356/399

(57) ABSTRACT

An improved method for aligning a plurality of optical elements in an optical device, includes: placing at least one optical element in a beam path; fixing the optical element in place without substantially compensating for errors in optical alignment; placing at least a one optical alignment element (OAE) in the beam path; and aligning the beam path to a desired beam path by adjusting the OAE. The alignment of the beam path substantially compensates for cumulative alignment errors in the beam path. The method increases the ease of manufacturing of optical devices and lowers the cost of manufacturing. The tolerances of the placement of optical elements are increased, and the optical element does not need special features for alignment.

### FIELD OF THE INVENTION

The present invention relates to the manufacturing of optical devices, and more particularly to the alignment of optical elements in the optical devices.

### BACKGROUND OF THE INVENTION

Precision alignment of an optical beam through optical elements in an optical device is necessary to ensure proper functioning of the device. Typical devices contain multiple optical elements, each having an associated alignment error in its placement that must be corrected. With conventional manufacturing methods, each optical element in the device is typically individually aligned in multiple dimensions as well as the source or target of the optical beam. However, manipulating multiple elements requires time and adds complexity to the alignment process, and it can be expensive, and is often difficult due to access restrictions. In addition, aligning the source or the target is difficult since they are typically electrically powered and may have unique mounting or monitoring requirements. Also, the source or target is generally the largest element and requiring it to move for the purpose of alignment may increase the form factor of the entire device. In addition, higher capacity devices require more optical channels, requiring more precisely aligned element and/or increased power efficiency through the system. This problem will become more acute as the industry continues to require higher speeds and higher data capacity capabilities. A problem also exists for systems which require the alignment of arrays of optical devices. Typically, the arrays are aligned by hand, which is difficult and cumbersome.

Accordingly there exists a need for an improved method of aligning optical elements in an optical device. The improved method should simplify the alignment of multiple optical elements without sacrificing precision. This simplicity should be maintained even when the number of optical elements in the device increases. The present invention addresses such a need.

### SUMMARY OF THE INVENTION

An improved method for aligning a plurality of optical elements in an optical device, includes: placing at least one optical element in a beam path; fixing the optical element in place without substantially compensating for errors in optical alignment; placing at least one optical alignment element (OAE) in the beam path; and aligning the beam path to a desired beam path by adjusting the OAE. The alignment of the beam path substantially compensates for cumulative alignment errors in the beam path. The method increases the ease in the manufacturing of optical devices and lowers the cost of manufacturing. Because only the OAE needs to be accessed and moved for alignment, the size of the device can be smaller. Also, the tolerances of the placement of optical elements are increased, and the optical element does not need special features for alignment.

### BRIEF DESCRIPTION OF THE FIGURES

FIG. 1 is a flowchart illustrating an embodiment of a method for aligning optical elements in accordance with the present invention.

FIG. 2 illustrates a first embodiment of an optical device manufactured utilizing the method for aligning optical elements in accordance with the present invention.

FIG. 3 illustrates a second embodiment of an optical device manufactured utilizing the method for aligning optical elements in accordance with the present invention.

FIG. 4 illustrates a conventional method for aligning optical elements utilizing a mirror as an alignment element.

FIG. 5 illustrates a top, side, and cross-sectional orthogonal views of the prism as the OAE in the method for aligning optical elements in accordance with the present invention.

FIG. 6 illustrates an isometric view of the prism as the OAE in the method for aligning optical elements in accordance with the present invention.

FIG. 7 illustrates the positioning of the beam with a prism movement in the x-direction.

FIG. 8 illustrates the positioning of the beam with a prism movement in the θₓ direction.

FIG. 9 illustrates the positioning of the beam with a prism movement in the z-direction.

FIG. 10 illustrates the positioning of the beam with a prism movement in the θ_{z} direction.

FIG. 11 illustrates the positioning of the beam with a prism movement in the y-direction and in the θ_{y} direction.

FIG. 12 illustrates the two-axis Hill Climb Alignment algorithm.

FIG. 13 is a flowchart illustrating an embodiment of the multi-axes Hill Climb Alignment algorithm utilized in the method for aligning optical elements in accordance with the present invention.

FIG. 14 illustrates an embodiment of a single-channel device manufactured using the method for aligning optical elements in accordance with the present invention.

FIG. 15 illustrates a first embodiment of a multi-channel device manufactured using the method for aligning optical elements in accordance with the present invention.

FIG. 16 illustrates a second embodiment of a multi-channel device manufactured using the method for aligning optical elements in accordance with the present invention.

FIG. 17 illustrates an embodiment of a light source in accordance with the present invention.

FIG. 18 illustrates an embodiment of a detector in accordance with the present invention.

FIG. 19 illustrates an example multi-channel device with the light source or detector in accordance with the present invention.

FIG. 20 illustrates an isometric view and a bottom view, of an embodiment of the chassis in accordance with the present invention.

FIG. 21 illustrates an embodiment of method of positioning and fixing the optical alignment element to the chassis in accordance with the present invention.

FIG. 22 illustrates an embodiment of a system for the method for aligning optical elements in accordance with the present invention.

### DETAILED DESCRIPTION

The present invention provides an improved method of aligning optical elements in an optical device. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

An embodiment of the method in accordance with the present invention aligns a beam path in an optical device by adjusting the placement and orientation of an optical alignment element (OAE) in a beam path. Even as the number of optical elements in the device increases, alignment of the beam path through the adjustment of the OAE substantially compensates for the cumulative alignment errors of the other optical elements in the beam path.

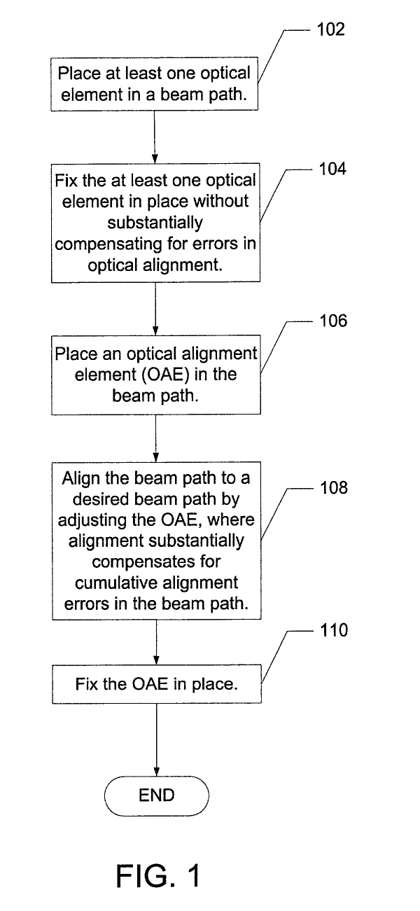

To more particularly describe the features of the present invention, please refer to FIGS. 1 through 22 in conjunction with the discussion below.

FIG. 1 is a flowchart illustrating an embodiment of a method for aligning optical elements in accordance with the present invention. First, at least one optical element is placed in a beam path, via step 102. Next, the at least one optical element is fixed in place without substantially compensating for errors in optical alignment, via step 104. An optical alignment element (OAE) is also placed in the beam path, via step 106. The beam path is aligned to a desired beam path by adjusted the placement and orientation of an OAE, via step 108. The alignment substantially compensates for the cumulative alignment errors in the beam path. The order of placement of the at least one optical element and the OAE in the beam path is irrelevant to the aligning step 108. The OAE is then fixed in place, via step 110.

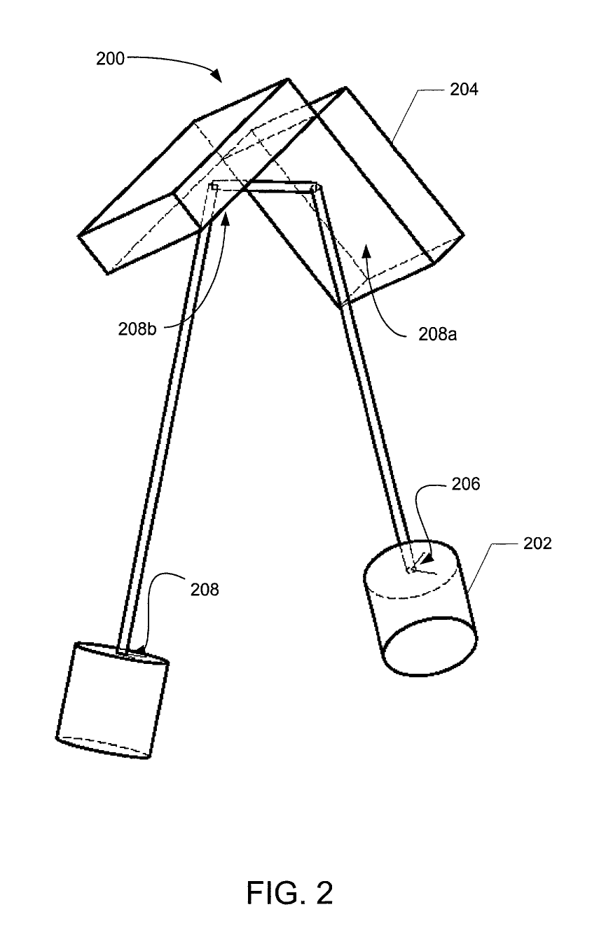

FIG. 2 illustrates a first embodiment of an optical device manufactured utilizing the method for aligning optical elements in accordance with the present invention. The device 200 comprises at least one optical element 202, placed at a first location 206, and an OAE 204, where the at least one optical element 202 and the OAE 204 are in a beam path between the first location 206 and a second location 208. In this embodiment, the OAE 204 comprises two coupled, non-parallel and non-co-planar reflective surfaces 208a-208b. In other embodiments an OAE can also include but is not limited to two coupled, non-parallel and non-co-planar surfaces in which one or more of the surfaces can include a refractive or defractive element, or an OAE can be any other element or coupled optical system configured to allow a beam to be adjusted in four or more degrees of freedom. The at least one optical element 202 is placed in the beam path and fixed in place without substantially compensating for errors in optical alignment. The OAE 204 is placed in the beam path as well. A beam is then provided for the beam path. The beam can traverse either from the first location 206 to the second location 208, or vice versa. The position and orientation of the OAE 204 is adjusted to align the beam path to a desired beam path. When the beam path is considered to be “aligned” depends upon an application's performance requirements, such as the specification of a larger device or system within which the device 200 is to be used. For example, the desired beam path can be the beam path when it is received at location 208 with a certain power level. The alignment substantially compensates for the cumulative alignment errors of the at least one optical element 202. When the alignment is considered to “substantially compensate” for cumulative alignment errors depends on an application's performance requirement. In this manner, optical alignment of the device 200 is accomplished using OAE 204.

In one embodiment, the OAE 204 is added to the beam path solely for the purpose of aligning the beam path. In other embodiments the OAE design can be optimized for packaging stability, mechanical stability, beam displacement sensitivity, to achieve a desired light path in a system, or for any other design requirement of the device or system in which it is used. In still other embodiments, additional active or passive optic elements, subsystems, systems or further optical surfaces or features can be coupled to or otherwise added or formed into or on to an OAE in order to achieve a desired effect on a beam passing through the OAE including but not limited to one or more flat or curved refracting, diffracting, or reflecting surfaces, such as one or more lens, mirror, wedge, diffraction grating, optical fiber, edge filter, reflective notch filter, band-pass filter, or any other type of filter.

Although the first embodiment is illustrated as comprising the at least one optical element 202 and the OAE 204, additional optical elements may be placed in the beam path without substantially compensating for errors in optical alignment. The alignment of the beam path would still substantially compensate for the cumulative alignment errors of the at least one optical element 202 and the additional optical elements. In other embodiments multiple OAE's 204 can also be placed in the beam path. These OAE's can be adjusted to iteratively align the beam path. Additional active or passive optical elements, subsystems or systems may be added to the beam path between iterations. Additional OAE's can be used, for example, when expanding or upgrading a system.

Example optical elements which can be placed at the first location 206 includes, but is not limited to, lenses, filters, mirrors, collimators, lasers, detectors, optical fibers, fiber collimators, gratings, or any other passive or active optical system or subsystem. Any of the optical elements can also be placed at location 208. In addition, optical systems can be placed at either locations 206 or 208, so that the beam path between an optical system and at location 208 is aligned to the desired beam path. For example, arrays of optical devices can be placed at locations 206 or 208, and one or more OAE 204 configured serially or arrayed are adjusted to align the beam paths between the array at location 206 and the array at location 208 to desired beam paths.

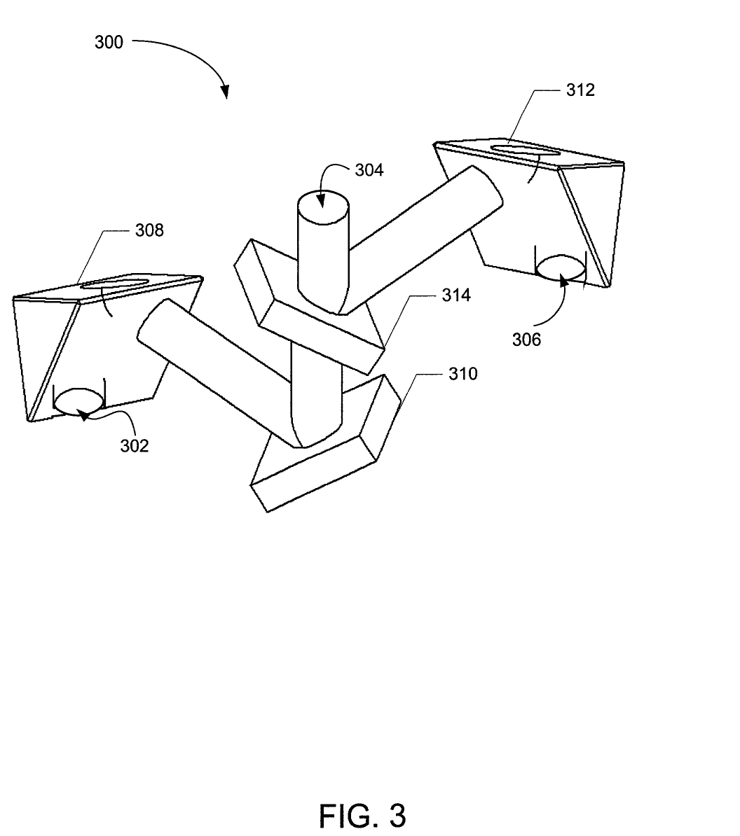

FIG. 3 illustrates a second embodiment of an optical device manufactured utilizing the method for aligning optical elements in accordance with the present invention. The device 300 is a multi-beam device, comprising at least two beam paths. A first OAE 308 and a first optical element 310 are placed in a first beam path between a first location 302 and a second location 304. A second OAE 312 and a second optical element 314 are placed in a second beam path between a third location 306 and the second location 304. As discussed above, each OAE 308 and 312 comprises two coupled, non-parallel and non-co-planar surfaces. The first optical element 310 is placed in the first beam path and fixed in place without substantially compensating for errors in optical alignment. The second optical element 314 is placed in the second beam path and fixed in place without substantially compensating for errors in optical alignment. In the embodiment of FIG. 3, optical element 314 is in the first beam path, however, in other embodiments this need not be the case. The first 308 and second 312 OAE are also placed in the first and second beam paths, respectively. The order in which the first 310 and second 314 optical elements and the first 308 and second OAE 312 are placed in their respective beam paths is irrelevant to the method in accordance with the present invention.

A first beam is then provided for the first beam path. The placement and orientation of the first OAE 308 is adjusted to align the first beam path to a first desired beam path. The alignment of the first beam path substantially compensates for the cumulative alignment errors in the first beam path. A second beam is provided for the second beam path. The placement and orientation of the second OAE 312 is then adjusted to align the second beam path to a second desired beam path. The alignment of the second beam path substantially compensates for the cumulative alignment errors in the second beam path.

Although the second embodiment is illustrated as comprising the first optical element 310 and the first OAE 308 in the first beam path, and comprising the second optical element 314 and the second OAE 312 in the second beam path, additional optical elements may be placed in either beam path without substantially compensating for errors in optical alignment without departing from the spirit and scope of the present invention. The aligning of the first beam path by adjusting the first OAE 308 would still substantially compensate for the cumulative alignment errors of the first optical element 310 and the additional optical elements placed in the first beam path. The aligning of the second beam path by adjusting the second OAE 312 would still substantially compensate for the cumulative alignment errors of the second optical element 314 and the additional optical elements placed in the second beam path.

The two coupled non-parallel non-co-planar surfaces of the OAE 308 or 312 allows the method in accordance with the present invention to provide advantages not available with conventional methods of alignment. To assist in describing these advantages, the disadvantages of utilizing a conventional mirror with a single reflective surface is first described.

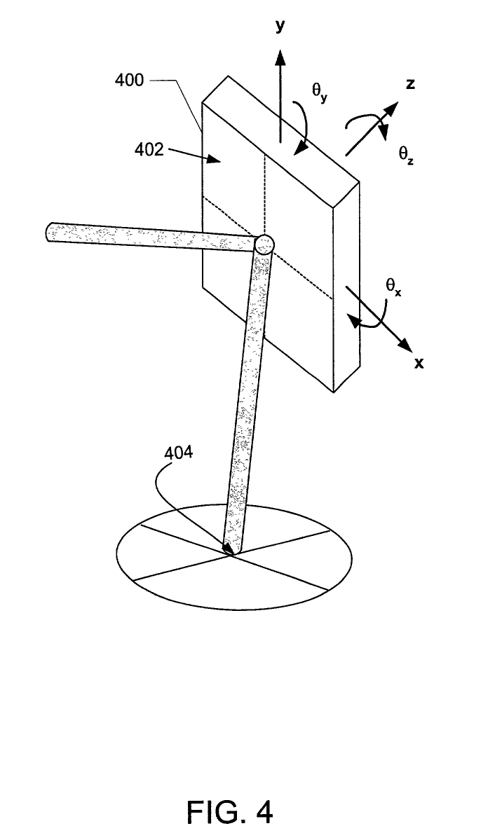

FIG. 4 illustrates a conventional method for aligning optical elements utilizing a mirror as an alignment element. The mirror 400 has one reflective surface 402. A beam is reflected from the reflective surface 402 onto a location 404. Assume that Cartesian axes “x”, “y”, and “z” are defined as illustrated in FIG. 4. The beam can be aligned to the location 404 by rotating the mirror 400 about the x-axis (θₓ), rotating about the y-axis (θ_{y}), and by translating along the z-axis. Translations along the x-axis or the y-axis or rotation about the z-axis have no effect on the positioning of the beam due to the symmetry of the mirror 400. The mirror 400 thus only has three degrees of freedom which affects the beam.

However, these three degrees of freedom are not adequate for all alignment situations. For example, if an emitter beam is defined as a beam emitted from a first location in three-dimensional space, and a receiver beam is defined as a desired beam path to be received by a second location in the same three-dimensional space, then in order to accomplish alignment of the emitter beam path to the desired beam path, the emitter beam and the receiver beam must not only intersect at some point in the three-dimensional space but also be co-linear. If the emitter beam and receiver beam happen to intersect, then at the point of intersection, a mirror can be placed to make the beams collinear. However, if the beams do not intersect then a mirror can be used used to make the beams parallel, but not co-linear. Therefore, in some situations, positioning the emitter beam and the receiver beam with the three degrees of freedom described above still would not cause them to intersect and be co-linear. A fourth degree of freedom which affects the beam is required. This fourth degree of freedom is not possible with a mirror, such as mirror 400, since translations along the x-axis or the y-axis or rotation about the z-axis have no effect on the positioning of the beam due to the symmetry of the mirror 400. In contrast, the OAE in accordance with the present invention provides a fourth degree of freedom which affects the beam, as illustrated below.

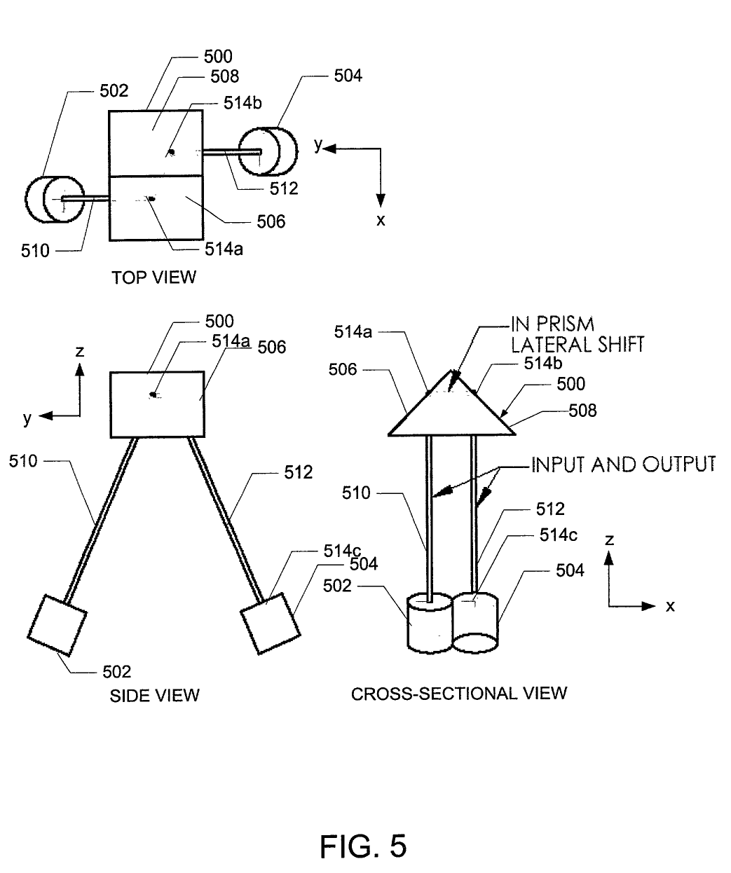

FIGS. 5-11 illustrate an embodiment of the OAE in the method for aligning optical elements in accordance with the present invention. In this embodiment, the OAE is a prism 500. For illustrative purposes, the Cartesian x-axis, y-axis, and z-axis are defined as shown in FIGS. 5-11.

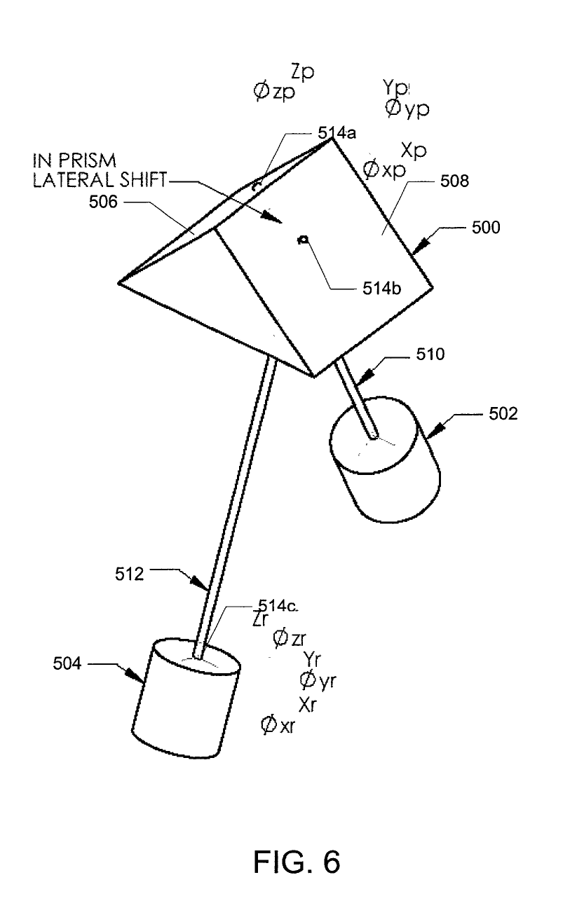

FIG. 5 illustrates a top, side, and cross-sectional orthogonal views of the prism as the OAE in the method for aligning optical elements in accordance with the present invention. The top view illustrates the prism 500 along the z-axis; the side view illustrates the prism 500 along the x-axis; and the cross-sectional view illustrates the prism 500 along the y-axis. FIG. 6 illustrates an isometric view of the prism as the OAE in the method for aligning optical elements in accordance with the present invention. In FIGS. 5 and 6, an emitter 502 provides an emitted beam 510. The emitted beam 510 enters the prism 500 and reflects off a first surface 506 at point 514a to a second surface 508. The beam reflects off the second surface 508 at point 514b and exists the prism 500 as reflected beam 512. The reflected beam 512 travels to point 514c on a receiver 504. The first 506 and second 508 surfaces are non-parallel and non-co-planar, and one or both surfaces 506 and 508 includes a refractive or defractive element.

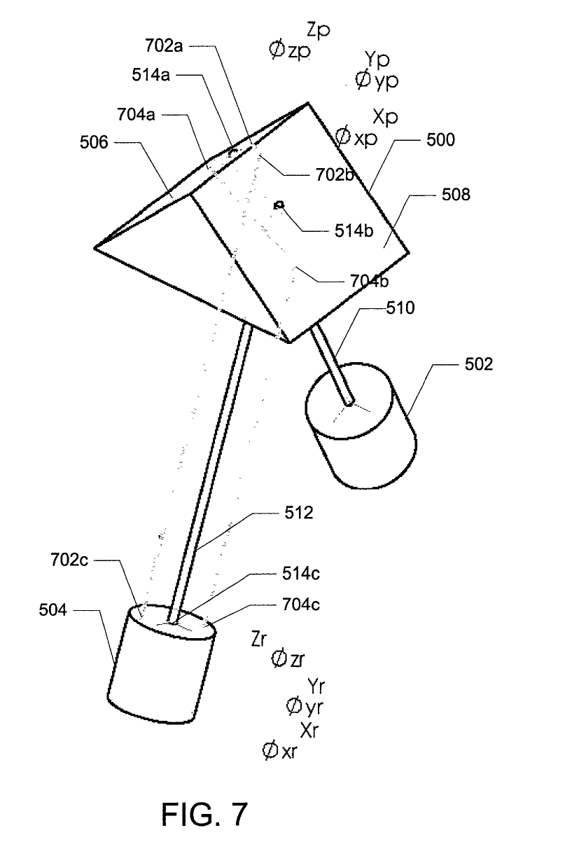

FIGS. 7-11 illustrate the positioning of a beam with various prism movements. The x-, y-, and z-axes at the prism 500 and receiver 504 are defined as shown in FIGS. 7-11. FIG. 7 illustrates the positioning of the beam with a prism movement in the x-direction. A movement of the prism 500 along the prism x-axis (Xₚ) produces a shift along the receiver x-axis (Xᵣ) and a smaller shift along the receiver y-axis (Yᵣ). One of ordinary skill in the art will understand that with the axes as defined above, the shift of the reflected beam 512 along Yᵣ results from some coupling along the prism z-axis (Zₚ), where movement of prism 500 along Xₚ results in additional path length for the beam. For example, the prism 500 can be moved such that the emitted beam 510 is reflected from the first surface 506 at point 702a, reflected from the second surface 508 at point 702b, and travels to point 702c on the receiver 504. For another example, the prism 500 can be moved such that the emitted beam 510 is reflected from the first surface 506 at point 704a, reflected from the second surface 508 at point 704b, and travels to point 704c on the receiver 504.

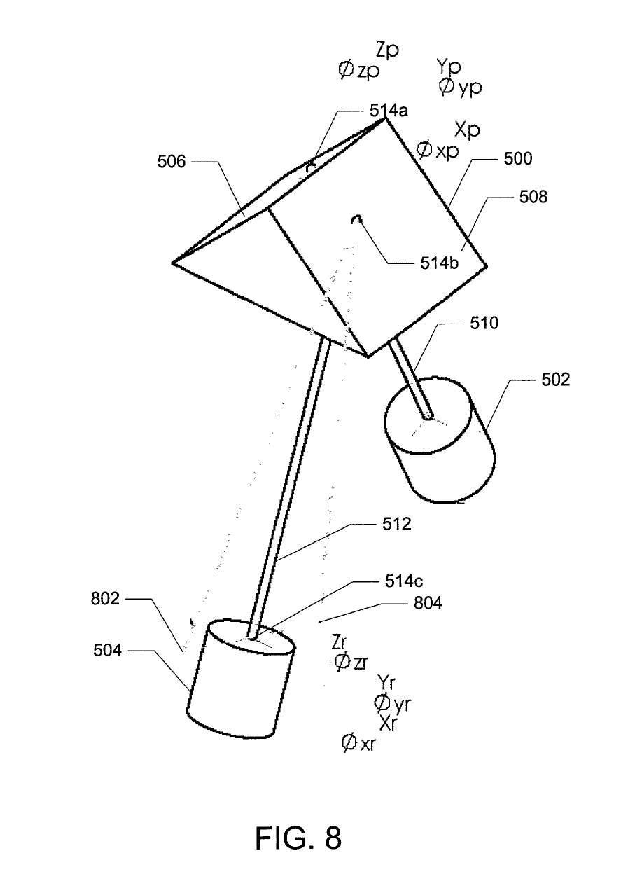

FIG. 8 illustrates the positioning of the beam with a prism movement in the θₓ direction. A movement of the prism 500 in the prism θₓ direction results in a shift of the reflected beam 512 along Yᵣ and rotated in the receiver θₓ (θₓᵣ) direction. For example, the prism 500 can be moved such that the emitted beam 510 is reflected from the first surface 506 approximately at point 514a, reflected from the second surface 508 at approximately point 514b, and travels either to point 802 or 804 on the receiver 504. Since the point 514a on the first surface 506 is moved a small amount compared to the movement of the points 802 or 804 on the receiver 504, the angle of θ_{x,} is changed. Thus, there are small changes in the points 514a and 514b when rotating about the prism θₓ axis (θₓₚ).

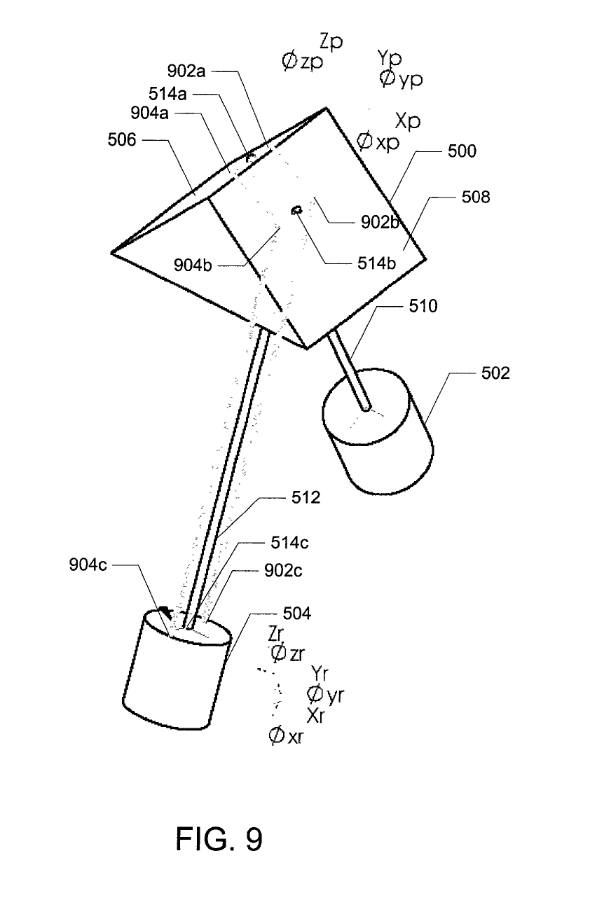

FIG. 9 illustrates the positioning of the beam with a prism movement in the z-direction. A movement of the prism 500 along Zₚ results in a shift of the reflected beam 512 along Yᵣ. For example, the prism 500 can be moved such that the emitted beam 510 is reflected from the first surface 506 at point 902a, reflected from the second surface 508 at point 902b, and travels to point 902c on the receiver 504. For another example, the prism 500 can be moved such that the emitted beam 510 is reflected from the first surface 506 at point 904a, reflected from the second surface 508 at point 904b, and travels to point 904c on the receiver 504.

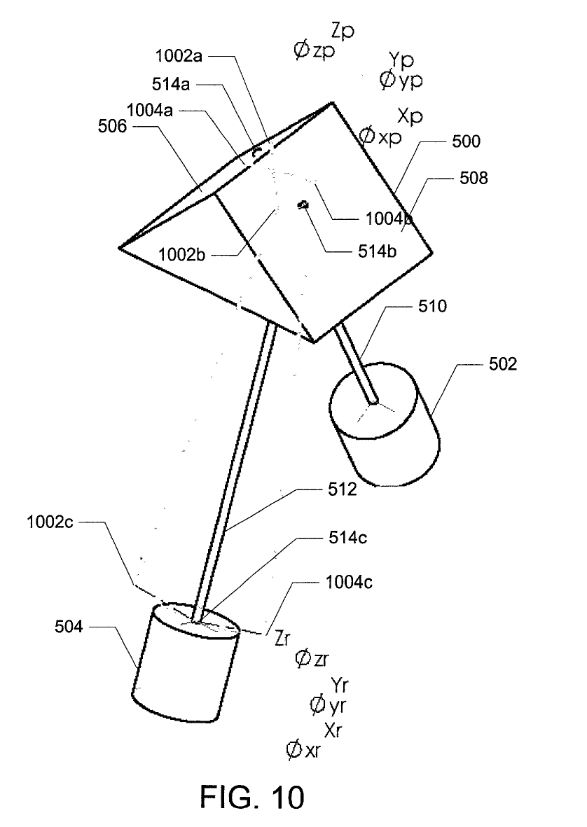

FIG. 10 illustrates the positioning of the beam with a prism movement in the θ_{Z} direction. A movement of the prism 500 in the prism θ_{Z} direction (θ_{zp}) results in a shift of the reflected beam 512 along the Xᵣ, and about the receiver θ_{y} (θ_{yr}) direction and a smaller shift along the Yᵣ and about the θᵣ direction. For example, the prism 500 can be moved such that the emitted beam 510 is reflected from the first surface 506 at point 1002a, reflected from the second surface 508 at point 1002b, and travels to point 1002c on the receiver 504. For another example, the prism 500 can be moved such that the emitted beam 510 is reflected from the first surface 506 at point 1004a, reflected from the second surface 508 at point 1004b, and travels to point 1004c on the receiver 504.

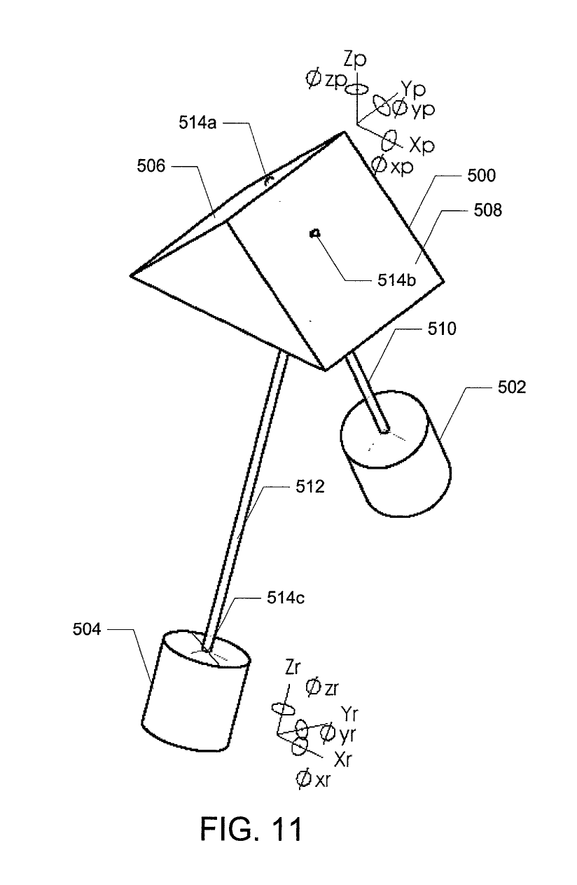

For the sake of completeness, FIG. 11 illustrates the positioning of the beam with a prism movement in the prism y-direction and in the prism θ_{y} (θ_{yp}) direction. A movement of the prism 500 in the prism y-direction (Yₚ) and the θ_{yp} direction results in a negligible shift in the reflected beam 512.

Thus, the prism 500 provides four degrees of freedom which affect the reflected beam 512: translation of the reflected beam 512 along Xᵣ, translation of the reflected beam 512 along Yᵣ, rotation of the reflected beam 512 about θₓᵣ and rotation of the reflected beam 512 about θ_{yr}. If the receiver 504 is an optical fiber, then the translations along Xᵣ and Yᵣ center the reflected beam 512 on the face of the fiber, and the rotations about θ_{xr and θ}_{yr} ensures that the reflected beam 512 enters the fiber perpendicular to the fiber's face. With these four degrees of freedom which affect the receiver beam 512, the prism 500 can align light beams between two locations.

Although the axes are defined as illustrated in FIGS. 5-11, one of ordinary skill in the art will understand that the axes can be defined in other ways without departing from the spirit and scope of the present invention.

The present invention provides significant advantages over conventional methods in the manufacturing of optical devices. The method in accordance with the present invention allows all optical elements in a device, other than the OAE 204, to be placed and fixed in place without substantially compensating for optical alignment errors, such as using a reference surface or a vision system, or some other system or method that does not substantially compensate for optical alignment errors. The OAE 204 is inserted into the beam path, and the beam is aligned to a desired beam path, where alignment of the beam path substantially compensates for cumulative alignment errors in the beam path. This greatly increases the ease in the manufacturing of optical devices, especially for devices with numerous optical elements, and lowers the cost of manufacturing. Because only the OAE 204 needs to be accessed and moved for alignment, the size of the device can be smaller. Also, the tolerances of the placement of optical elements are also increased, and the optical elements do not require special features for alignment.

The OAE 204 can be engineered for thermal stability by choosing a material with a low coefficient of thermal expansion, by choosing a geometry which limits the movement of the OAE 204 as the temperature changes, or by choosing a coefficient of thermal expansion which matches or nearly matches its surrounding points of contact with the coefficient of thermal expansion of the system. The OAE 204 can be engineered for beam displacement sensitivity by choosing a geometry which provides a desired angle between the two reflective surfaces 208a-208b. The OAE 204 can also be engineered with special mounting, or other features, or with a desired size, the shape and size of the OAE 204 correlates to the amount of alignment errors for which can be compensated. Also, a mounting element may be fixed to the OAE 204 which substantially improves the method of positioning, fixing, and stabilizing the OAE 204 over temperature and improves the reliability or packaging of a system that includes the OAE 204 by, for example, improving the ability to hermetically seal the system.

An OAE 204 can be designed to achieve a desired optical path, such as a compact system design with an optical “fold” in the beam path provided by the two surfaces 208a-208b of the OAE 204. For an OAE 204 with Total Internal Reflection (TIR), a very low insertion loss is possible.

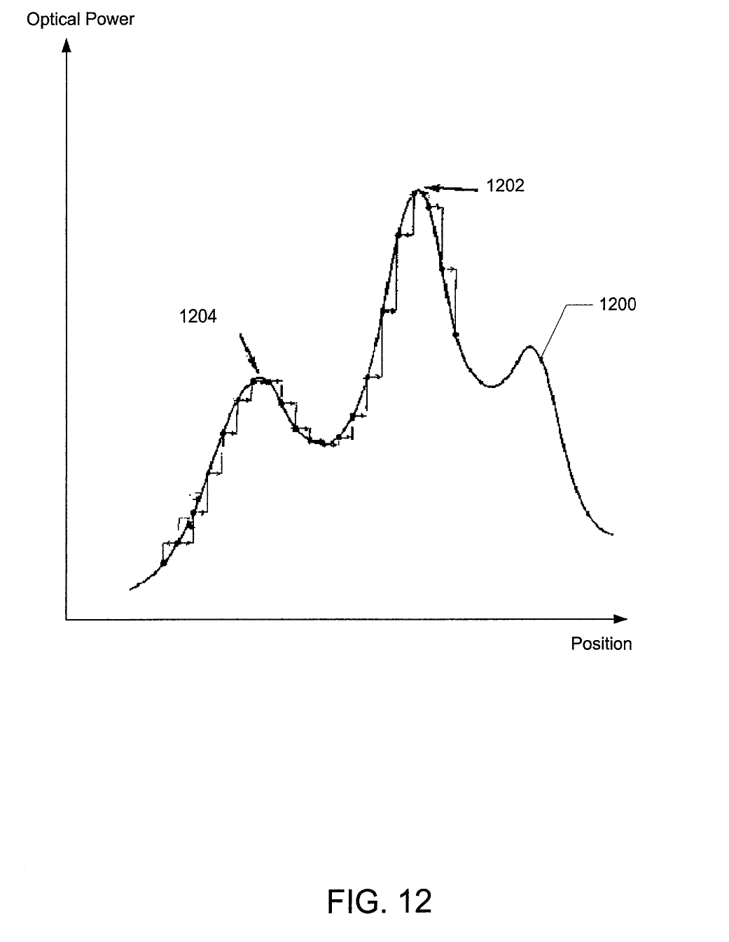

The OAE 204 may be oriented using a multi-axes alignment algorithm. To assist in understanding the multi-axes alignment algorithm, a simpler, two-axes alignment algorithm is first described. FIG. 12 illustrates the two-axis alignment algorithm. The schematic diagram of FIG. 12 has a vertical axis representing optical power, and the hill shaped curve 1200 representing the measured optical power of a beam as it enters a receiving location, such as either the first 206 or the second 208 location (FIG. 2) at various placements and orientations of the OAE 204. The goal of the alignment algorithm is to find the peak 1202 of the curve 1200 to within the application's performance requirements. The placement and orientation of the OAE 204 are changed in incremental steps. At each step, the optical power at the receiving location is detected and measured. If the optical power drops at a subsequent step, a peak has been found. To avoid getting trapped at local peaks 1204 in the curve 1200, the optical power is checked beyond each local maximum point. As the power level reaches the absolute peak 1202, repeated iterations of adjusting the OAE's 204 placement and orientation can be performed with increasingly smaller steps in order to detect the peak 1202 more accurately.

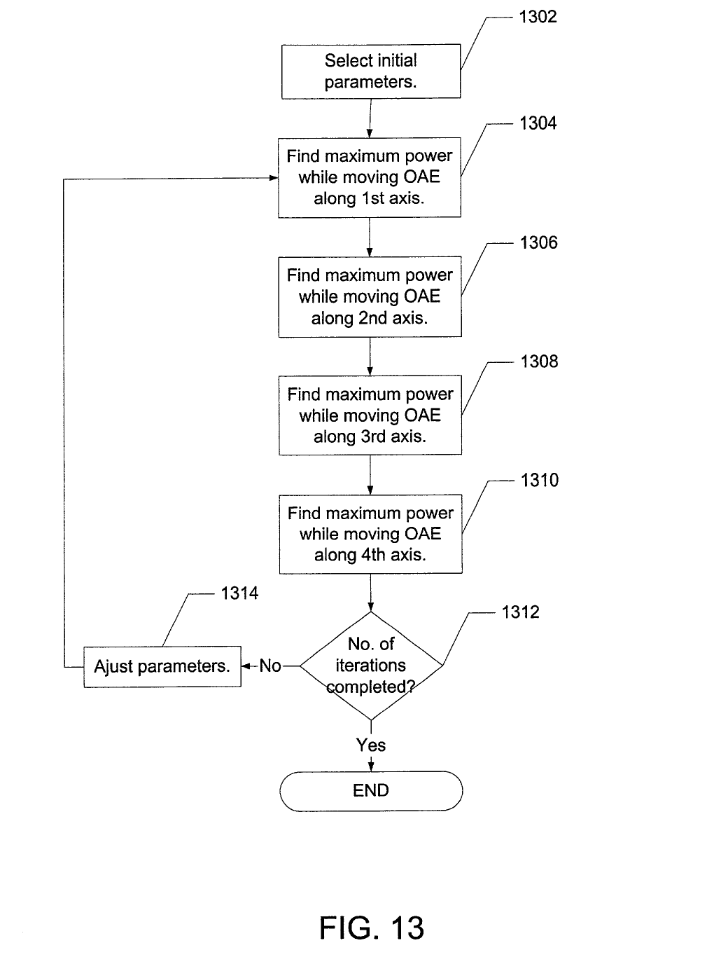

The multi-axes alignment algorithm performs the incremental steps for two or more axes. The axes need not correspond to Cartesian or orthogonal axis and can be related to system, phsical or other characteristics of the optical device and/or OAE being aligned. FIG. 13 is a flowchart illustrating the embodiment of the multi-axes alignment algorithm utilized in the method for aligning optical elements in accordance with the present invention. The alignment algorithm is performed on the four axes of the OAE 204 which provides the four degrees of freedom that affects the reflected beam. First, the initial parameters of the algorithm are selected, via step 1302. The parameters can comprise the iteration step size and the number of iterations.

It can also comprise the definition of the four axes. Other parameters are possible. Then, the maximum power is found while moving the OAE 204 along a first axis, via step 1304, moving the OAE 204 along a second axis, via step 1306, moving the OAE 204 along a third axis, via step 1308, and moving the OAE 204 along a fourth axis, via step 1310. The order and number of repetitions in which steps 1304 through 1310 are performed may vary. For example, the first iterations may be performed along the most sensitive axis, or multiple iterations can be performed for one or more axes before proceeding to the other axes. The order can be chosen to increase the speed or ease at which proper alignment is achieved. If the predetermined number of iterations have not been performed, via step 1312, then the parameters are adjusted, via step 1314. For example, the iteration step size can be made smaller. Then, steps 1304 through 1310 are repeated.

The method for aligning optical elements in accordance with the present invention may be used to manufacture many different optical devices. For example, it can be used to manufacture a single or multi-channel multiplexer, demultiplexer, transmitter, receiver, or transceiver, or any combination thereof.

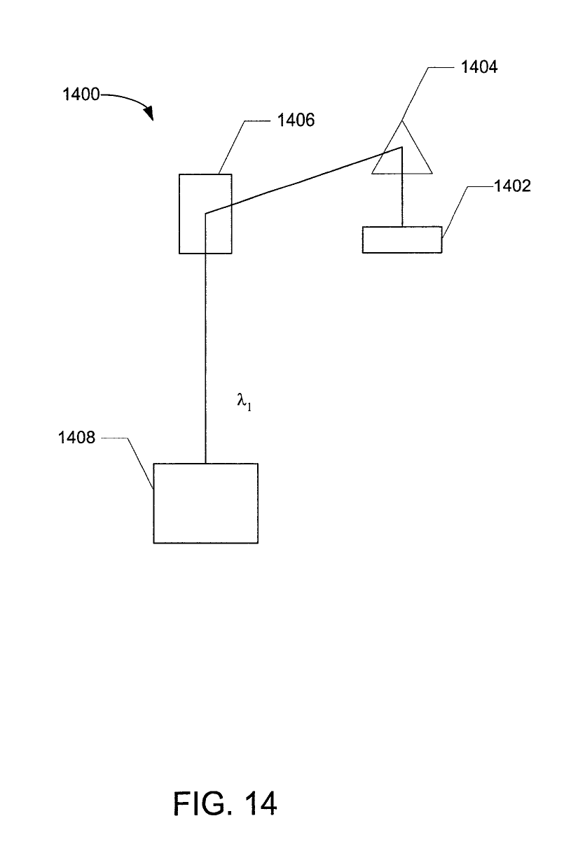

FIG. 14 illustrates an embodiment of a single-channel device manufactured using the method of aligning optical elements in accordance with the present invention. The device 1400 can be a single-channel transmitter or receiver or any other optical system or device, comprising an optical element 1402, an OAE 1404, a filter 1406, and an element 1408. In this embodiment, the filter 1406 can be a reflective or a transmissive filter, or some other optical element which performs the same function. The embodiment of FIG. 14 depicts 1406 as a band reflection filter, however in other embodiments 1406 can be any other optical element including but not limited to a band transmission filter, mirror, a polarizer a lens another optical system or subsystem optical element. As a transmitter, the optical element 1402 is some type of light source, such as a laser or an optical fiber. The light source emits a beam which traverses through the OAE 1404 as described above with FIG. 2. The beam exits the OAE 1404 to the filter 1406. The filter 1406 causes a wavelength, λ, or set of wavelengths, to traverse to the element 1408. The element 1408 is some type of output, such as a fiber, a detector, nozzle, lens, collimator, or any other passive or active optical system or subsystem.

As a receiver, the beam traverses the device 1400 in a direction that is reversed from the transmitter. As a receiver, the element 1408 is some type of light source, such as a laser or optical fiber. The element 1408 emits a beam comprising a wavelength λ, or set of wavelengths, which traverses the filter 1406 to the OAE 1404. The beam traverses the OAE 1404 to the optical element 1402, which is some type of output, such as a fiber, detector, lens collimator, or any other passive or active optical system of subsystem.

In manufacturing the device 1400, the optical element 1402, the element 1408, and the filter 1406 are placed in the beam path and fixed in place without substantially compensating for optical alignment errors. The OAE 1404 is placed in the beam path as well. The placement and orientation of the OAE 1404 is adjusted to align the beam path to a desired beam path. The alignment of the beam path substantially compensates for the cumulative alignment errors of the optical element 1402, the element 1408, and the filter 1406. Once aligned, the OAE 1404 is fixed in place.

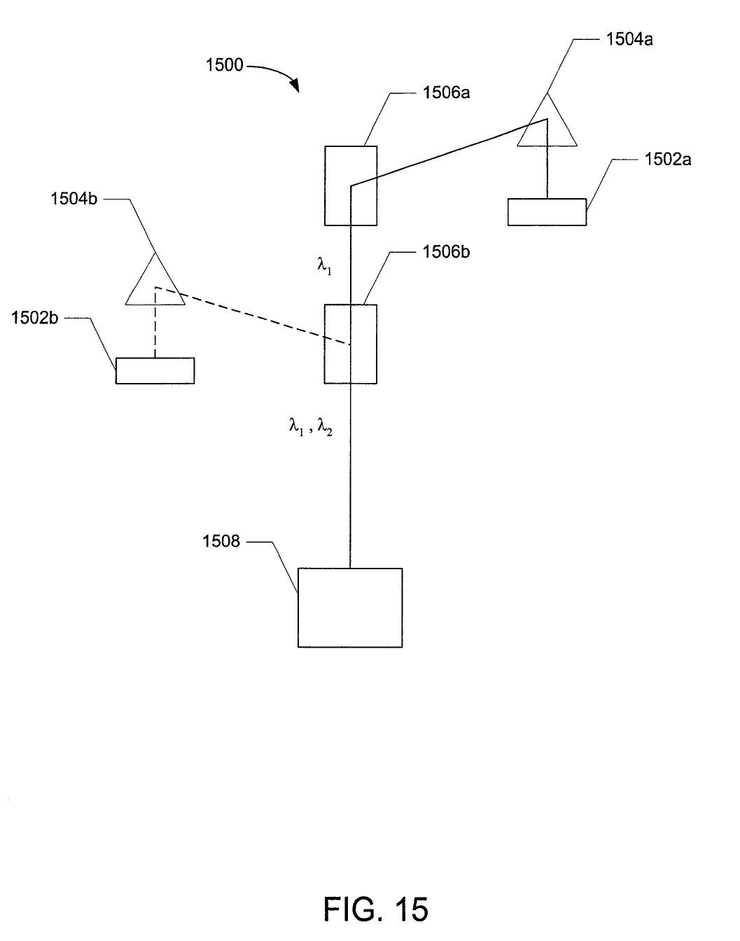

FIG. 15 illustrates a first embodiment of a multi-channel device manufactured using the method for aligning optical elements in accordance with the present invention. The device 1500 can be a passive or active multiplexer, demultiplexer, transmitter, receiver, or transceiver, or any combination thereof. In this embodiment, the device 1500 is a two-channel device, with two beam paths. In the first beam path, the device 1500 comprises a first optical element 1502a, a first OAE 1504a, a first filter 1506a, and an element 1508. In the second beam path, the device 1500 comprises a second optical element 1502b, a second OAE 1504b, a second filter 1506b, and the element 1508. In this embodiment, either filters 1506a or 1506b can be a reflective or transmissive filter, or some other optical element which performs the same or similar function, and in other embodiments filter 1506a can be a mirror or some other non-filtering reflective optical element. As a transmitter, the first 1502a and second 1502b optical elements are some type of light sources, such as lasers or optical fibers. The first optical element 1502a emits a beam which traverses through the first OAE 1504a. The beam exits the first OAE 1504a to the first filter 1506a. The first filter 1506a causes a first wavelength, λ₁, or set of wavelengths, to traverse to the element 1508. The element 1508 is some type of output, such as a fiber, nozzle, lens, focusing optic, collimator, or any other passive or active optical system or subsystem. The second optical element 1502b emits a beam which traverses through the second OAE 1504b. The exits the second OAE 1504b to the second filter 1506b. The second filter 1506b causes a second wavelength, λ₂, or set of wavelengths, to traverse to the element 1508. The first wavelength, λ₁, from the first filter 1506a is transmitted through the second filter 1506b. A multiplexed beam comprising λ₁ and λ₂ is transmitted to the element 1508.

As a receiver, the beams in the first and second beam paths traverse the device 1500 in a direction that's reversed from the transmitter. As a receiver, the first 1502a and second 1502b optical elements are some type of output, such as optical fibers, detectors, lenses, focusing optics, collimators, or any other passive or active optical systems or subsystems. The element 1508 is some type of light source, such as a laser or optical fiber. The element 1508 emits a multiplexed beam comprising λ₁ and λ₂ and transmits it to the second filter 1506b. The second filter 1506b causes λ₂ to traverse to the second OAE 1504b. The second wavelength, λ₂, traverses the second OAE 1504b and is transmitted to the second optical element 1502b. The first wavelength, λ₁, is transmitted through the second filter 1506b to the first filter 1506a. The first filter 1506a causes λ₁ to traverse to the first OAE 1504a. The first wavelength, λ₁, traverses through the first OAE 1504a and is transmitted to the first optical element 1502a.

As a transceiver, one beam path of the device 1500 functions similarly to a beam path in the transmitter while the other beam path functions similarly to a beam path in the receiver.

In manufacturing the device 1500, the first optical element 1502a, the second optical element 1502b, the element 1508, the first filter 1506a, and the second filter 1506b are placed in their respective beam paths and fixed in place without substantially compensating for optical alignment errors. The first OAE 1504a is placed in the first beam path, and the second OAE 1504b is placed in the second beam path. The placement and orientation of the first OAE 1504a is adjusted to align the first beam path to a first desired beam path. The alignment of the first beam path substantially compensates for the cumulative alignment errors of the first optical element 1502a, the element 1508, and the first filter 1506a in the first beam path. The placement and orientation of the second OAE 1504b is adjusted to align the second b beam path to a second desired beam path between the second 1502b. The alignment of the second beam path substantially compensates for the cumulative alignment errors of the second optical element 1502b, the element 1508, and the second filter 1506b in the second beam path. Once aligned, the OAE's 1504a-1504b are fixed in place.

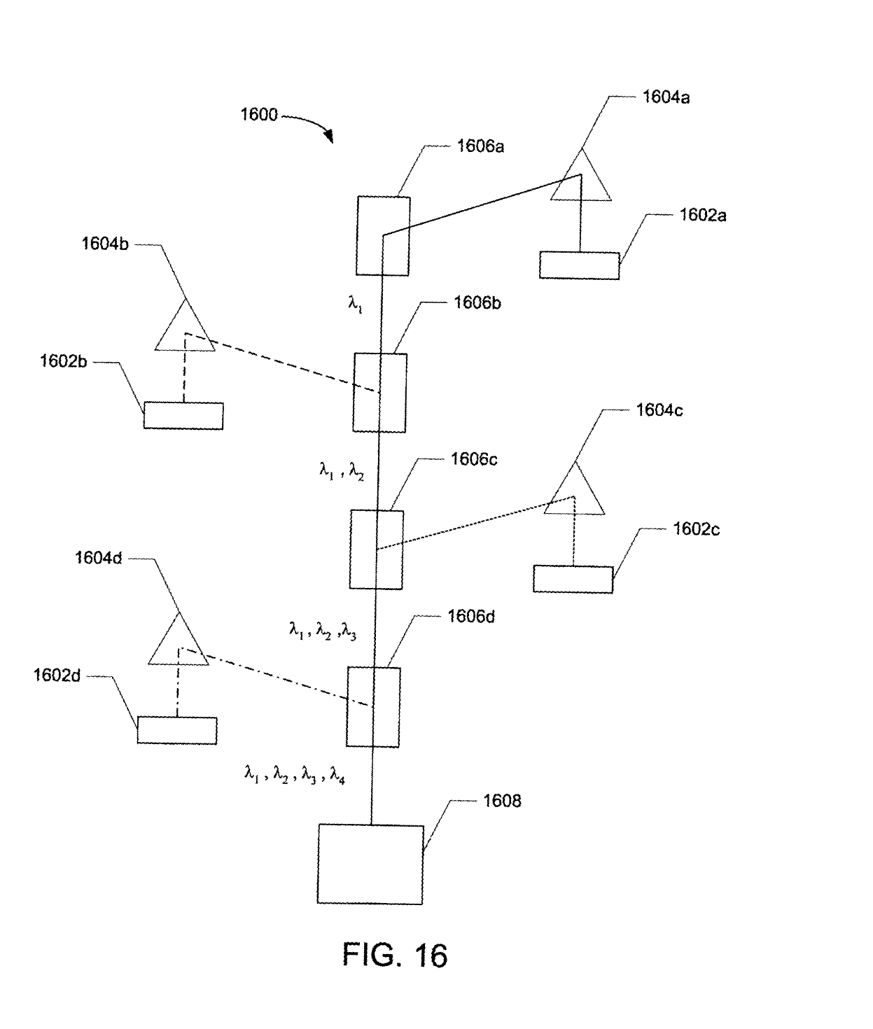

FIG. 16 illustrates a second embodiment of a multi-channel device manufactured using the method for aligning optical elements in accordance with the present invention. The device 1600 can be a passive or active multiplexer, demultiplexer, transmitter, receiver, or transceiver, or any combination thereof. In this second embodiment, the device 1600 is a four-channel device, with four beam paths. In the first beam path, the device 1600 comprises a first optical element 1602a, a first OAE 1604a, a first filter 1606a, and an element 1608. In the second beam path, the device 1600 comprises a second optical element 1602b, a second OAE 1604b, a second filter 1606b, and the element 1608. In the third beam path, the device 1600 comprises a third optical element 1602c, a third OAE 1604c, a third filter 1606c, and the element 1608. In the fourth beam path, the device 1600 comprises a fourth optical element 1602d, a fourth OAE 1604d, a fourth filter 1606d, and the element 1608. In this second embodiment, any of the filters 1606a-1606d can be a reflective or transmissive filter, or some other optical element which performs the same function.

As a transmitter, the optical elements 1602a-1602d are each some type of light source, such as a laser or optical fiber. The element 1608 is some type of output, such as a fiber, detector, nozzle, lens, focusing optic, collimator, or any other passive or active optical system or subsystem. The first optical element 1602a emits a beam which traverses through the first OAE 1604a. The beam exits the first OAE 1604a to the first filter 1606a. The first filter 1606a causes a first wavelength, λ₁, or set of wavelengths, to traverse to the element 1608. The second optical element 1602b emits a beam which traverses through the second OAE 1604b to the second filter 1606b. The second filter 1606b causes a second wavelength, λ₂, or set of wavelengths, to traverse to the element 1608. The first wavelength, λ₁, is transmitted through the second filter 1606b. The third optical element 1602c emits a beam which traverses through the third OAE 1604c to the third filter 1606c. The third filter 1606c causes a third wavelength, λ₃, or set of wavelengths, to traverse to the element 1608. The first and second wavelengths (λ₁, λ₂) are transmitted through the third filter 1606c. The fourth optical element 1602d emits a beam which traverses through the fourth OAE 1604d to the fourth filter 1606d. The fourth filter 1606d causes a fourth wavelength, λ₄, or set of wavelengths, to traverse to the element 1608. The first, second, and third wavelengths (λ₁, λ₂, λ₃) are transmitted through the fourth filter 1606d. A multiplexed beam comprising λ₁, λ₂, λ₃, and λ₄ is transmitted to the element 1608.

As a receiver, the beams in the first through fourth beam paths traverse the device 1600 in a direction that's reversed from the transmitter. As a receiver, the optical elements 1602a-1602d are each some type of outputs, such as optical fibers, detectors, lenses, focusing optics, collimators, or some other passive or active optical systems or subsystems. The element 1608 is some type of light source, such as a laser or optical fiber. The element 1608 emits a multiplexed beam comprising λ₁, λ₂, λ₃, and λ₄ and transmits it to the fourth filter 1606d. The fourth filter 1606d causes λ₄ to traverse to the fourth OAE 1604d. The fourth wavelength, λ₄, traverses the fourth OAE 1604d and is transmitted to the fourth optical element 1602d. The remaining wavelengths, λ₁, λ₂, and λ₃, are transmitted through the fourth filter 1606d to the third filter 1606c. The third filter 1606c causes λ₃ to traverse to the third OAE 1604c. The third wavelength, λ₃, traverses the third OAE 1604c and is transmitted to the third optical element 1602c. The remaining wavelengths, λ₁ and λ₂, are transmitted through the third filter 1606c to the second filter 1606b. The second filter 1606b causes λ₂ to traverse to the second OAE 1604b.

The second wavelength, λ₂, traverses the second OAE 1604b and is transmitted to the second optical element 1602b. The remaining wavelength, λ₁, is transmitted through the second filter 1606b to the first filter 1606a. The first filter 1606a causes λ₁ to traverse to the first OAE 1604a.

The first wavelength, λ₁, traverse the first OAE 1604a and is transmitted to the first optical element 1602a.

As a transceiver, one or more beam paths of the device 1600 function similarly to a beam path in the transmitter while the other beam paths function similarly to a beam path in the receiver.

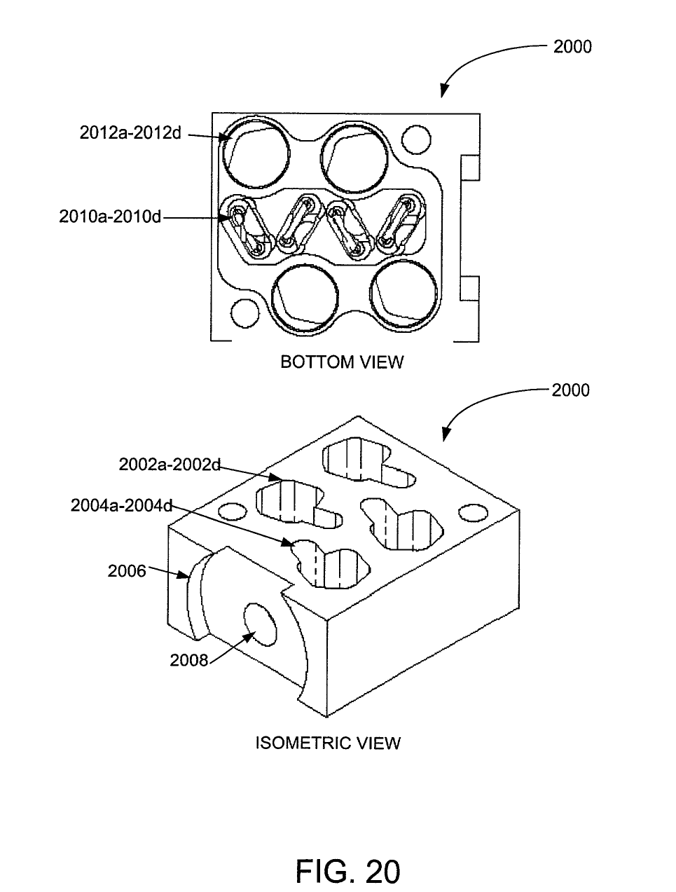

In manufacturing the device 1600, the optical elements 1602a-1602d, the element 1608, and the filters 1606a-1606d are fixed in place to a chassis (not shown) in their respective beam paths without substantially compensating for optical alignment errors. (The chassis is described below with reference to FIG. 20.) The OAE's 1604a-1604d are placed in their respective beam paths. The placement and orientation of the first OAE 1604a is adjusted to align the first beam path to a first desired beam path. The alignment of the first beam path substantially compensates for the cumulative alignment errors of the first optical element 1602a, the element 1608, and the first filter 1606a in the first beam path. The placement and orientation of the second OAE 1604b is adjusted to align the second beam path to a second desired beam path. The alignment of the second beam path substantially compensates for the cumulative alignment errors of the second optical element 1602b, the element 1608, and the second filter 1606b in the second beam path. The placement and orientation of the third OAE 1604c is adjusted to align the third beam path to a third desired beam path. The alignment of the third beam path substantially compensates for the cumulative alignment errors of the third optical element 1602c, the element 1608, and the third filter 1606c in the third beam path. The placement and orientation of the fourth OAE 1604d is adjusted to align the fourth beam path to a fourth desired beam path. The alignment of the fourth beam path substantially compensates for the cumulative alignment errors of the fourth optical element 1602d, the element 1608, and the fourth filter 1606d in the fourth beam path. Once aligned, the OAE's 1604a-1604d are fixed in place to the chassis.

Note that in this embodiment, the alignment for each wavelength is independent from the others. Thus, the alignment of one wavelength does not require realignment for any of the other wavelengths, increasing the ease of aligning the optical elements in the device as a whole.

Although the embodiments of the device manufactured utilizing the method in accordance with the present invention is described with one, two, and four channels, one of ordinary skill in the art will understand that devices which support any number of channels, as well has having different sizes or data rates, may be manufactured utilizing the method without departing from the spirit and scope of the present invention.

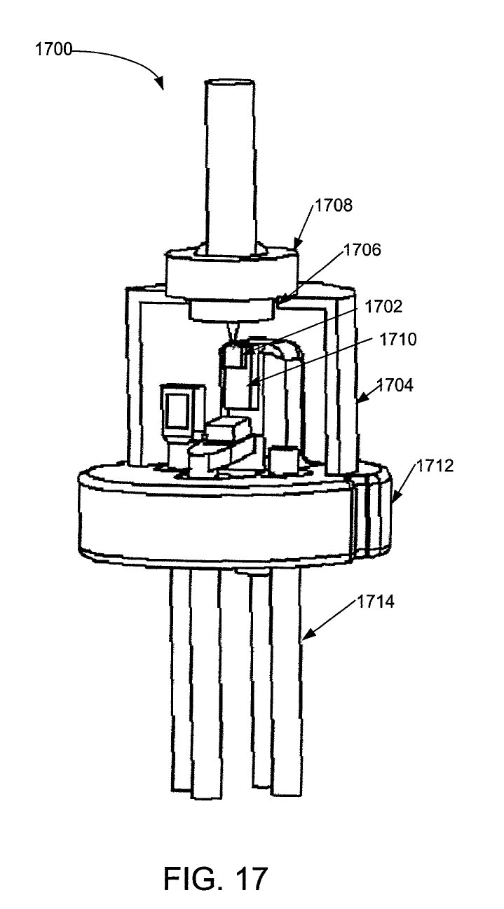

FIG. 17 illustrates an embodiment of a light source in accordance with the present invention. The light source 1700 can comprise either of the optical elements 1402 or 1408 of the device 1400 as a transmitter or receiver. The light source 1700 can also comprise any one or more of the optical elements 1502a-1502b or element 1508 of the device 1500 as a transmitter, receiver, or transceiver. The light source 1700 can also comprise one or more of the optical elements 1602a-1602d or element 1608 of the device 1600 as a transmitter, receiver, or transceiver.

The light source 1700 is a collimated laser package which comprises an emitter 1902 mounted on a submount 1710, which is mounted onto a header 1712. The emitter 1702 and submount 1710 are surrounded by a cap 1704 which is coupled to the header 1712. The ends of a plurality of the pins 1714 are coupled to the emitter 1702 or any other components (not shown) within the cap 1704 by wire bonds (not shown) or some other means. The other ends of the pins 1714 are coupled to an external circuit (not shown). The cap 1704 may comprise a material such as Kovar. The cap 1704 has an opening 1706 through which light from the emitter 1702 may traverse out of the light source 1700. The opening 1706 can house a lens 1708 for collimating the beam from the emitter 1702 as it exits the light source 1700. Alternatively, the opening 1706 can house a window (not shown) with the lens 1708 mounted outside of the cap 7904. The lens 1708 may be replaced by some other type of collimator. The lens 1708 may be aligned to the cap 1704 for accurate collimation, or the lens 1708 and cap 1704 may be aligned to the header 1712 and fixed. In other embodiments the light source can be temperature controlled, using for example a thermoelectric cooler, to achieve desired output characteristics such as wavelength drift.

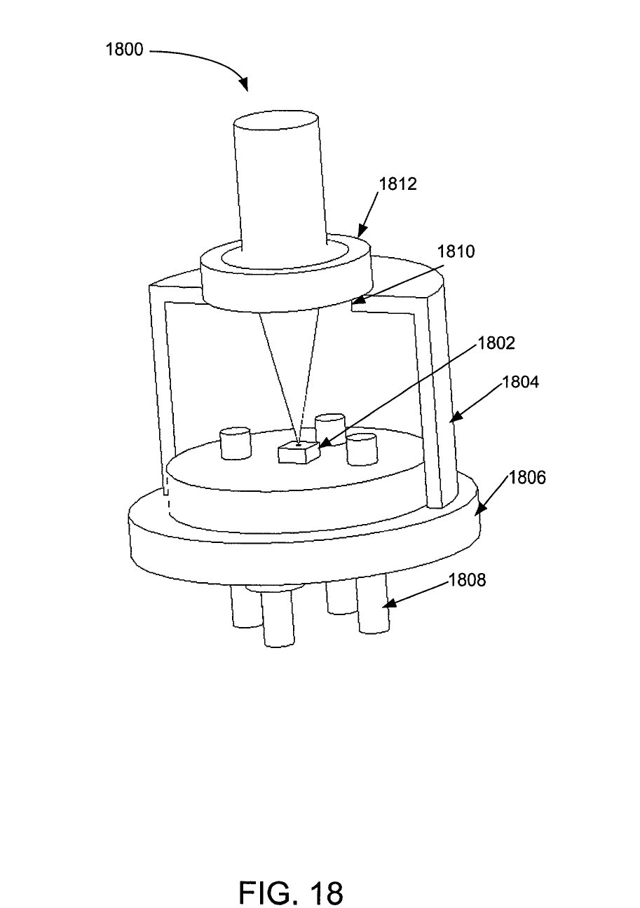

FIG. 18 illustrates an embodiment of a detector in accordance with the present invention. The detector package 1800 can comprise either of the optical elements 1402 or 1408 of the device 1400 as a transmitter or receiver. The detector package 1800 can also comprise one or more of the optical elements 1502a-1502b of the device 1500 as a receiver or transceiver. The detector package 1800 can also comprise one or more of the optical elements 1602a-1602d of the device 1600 as a receiver or transceiver.

The detector package 1800 comprises a detector 1802 residing on a header 1806. The detector 1802 is surrounded by a cap 1804. The cap 1804 also resides on the header 1806. The ends of a plurality of pins 1808 are coupled to the detector 1802 or any other components (not shown) within the cap 1804 by wire bonds (not shown) or some other means. The other ends of the pins 1808 are coupled to an external circuit (not shown). The cap 1804 has an opening 1810 through which light may enter the detector package 1800 to the detector 1802. The opening 1810 can house a lens 1812 for focusing a beam that enters the detector package 1800 onto the detector 1802. Alternatively, the opening 1810 can house a window (not shown) with the lens 1812 mounted outside of the cap 1804. The lens 1812 may be replaced by some other type of focusing element. The lens 1812 may be aligned to the cap 1804 for accurate focusing onto the detector 1802, or the lens 1812 and cap 1804 may be aligned to the header 1806 and fixed.

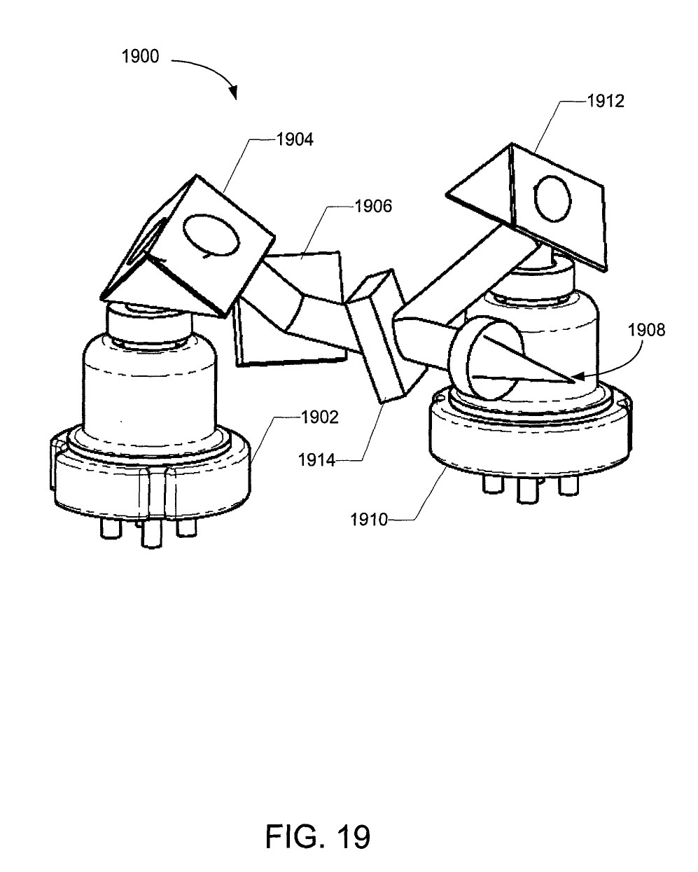

FIG. 19 illustrates an example multi-channel device which utilizes the light source or detector in accordance with the present invention. The device 1900 comprises a first optical element 1902, a first OAE 1904, and a first filter 1906 in a first beam path between the first optical element 1902 and a location 1908. The device 1900 also comprises a second optical element 1910, a second OAE 1912, and a second filter 1914 in a second beam path between the second optical element 1910 and a location 1908. The device 1900 would function similarly to the device 1500 (FIG. 15). If the device 1900 is a transmitter, then the optical elements 1902 and 1910 are each the light source 1700 (FIG. 17). If the device 1900 is a receiver, then the optical elements 1902 and 1910 are each the detector package 1800 (FIG. 18). If the device 1900 is a transceiver, then one of the elements 1902 or 1910 is the light source 1700 while the other is the detector package 1800.

The benefits realized by devices manufactured with the method in accordance with the present invention includes the low manufacturing cost due to the ease of alignment and the reduced size of the device. The device may be used in conjunction with many conventional systems to realize the unique advantages provided by the method for aligning optical elements in accordance with the present invention. For example, the compact design possible with the method enables multi-channel transceiver module scalability on line cards, i.e., allow the devices to be stacked side by side, which provides cost savings. The devices may be “pigtailed” as well. For example, one or more of the optical devices 1602a-1602d can be the output from another device, including, but not limited to, a multiplexer, demultiplexer, laser, detector, or any other passive or active system or subsystem. The compact design also enables more channels than conventional device form factors. Because of the modular design possible with devices manufactured with the method in accordance with the present invention, multiple multiplexers or active multi-channel systems can be serialized to build high channel count systems, such as N-channel passive optical multiplexers. The method also allows single mode fiber alignment within required tolerances.

The products and systems which can be manufactured with the method in accordance with the present invention include optical multiplexers/demultiplexers, transceivers, and switch or hub systems, including, but not limited to, GigaBit Interface Converters (GBIC), small form factor (SFF) transceivers, Bidi transceivers, Triplexers, fiber grating lasers (FGL), dense wavelength division multiplexing (DWDM) systems, and transceivers designed for capability with XAUI, XENPAK, XGP, or other transceiver-related standards, or standard promulgated by a standards body, including IEEE standards and the IEEE 802 standard.

FIG. 20 illustrates an isometric view and a bottom view, of an embodiment of the chassis in accordance with the present invention. In this embodiment, a chassis 2000 for a four-channel device, such as device 1600 (FIG. 16), is illustrated. A chassis for a device with fewer or more channels can also be provided without departing from the spirit and scope of the present invention. The chassis 2000 comprises four pockets 2002a-2002d, four lightpath slots 2004a-2004d, a nozzle bore 2006, a through hole 2008, four slots 2010a-2010d, and four bores 2012a-2012d. The nozzle bore 2006 houses a nozzle (not shown) which comprises the element 1608 (FIG. 16). Light to (or from) the element 1608 exits (or enters) the chassis 2000 via the through hole 2008.

The four pockets 2002a, 2002b, 2002c, and 2002d house the first 1604a, second 1604b, third 1604c, and fourth 1604d OAE's, respectively. The pockets 2002a-2002d allow the OAE's 1604a-1604d to be accessed and moved during the alignment process. Once aligned, the OAE's 1604a-1604d are each fixed to the chassis 2000.

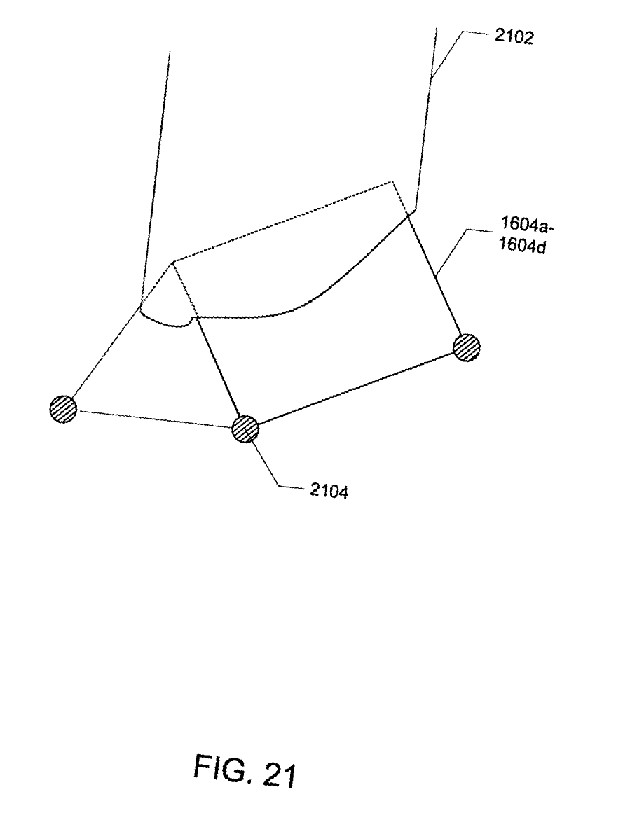

FIG. 21 illustrates an embodiment of a method of positioning and fixing the alignment element to the chassis in accordance with the present invention. A vacuum tube 2102 holds each OAE 1604a-1604d within its pocket 2002a-2002d during the alignment process. Once the alignment is accomplished, a dispenser (not shown) applies epoxy 2104 to the corners of the each OAE 1604a-1604d. In this embodiment, an ultraviolet-curable epoxy is used. Once the epoxy 2104 is applied, the OAE's 1604a-1604d and the epoxy are bombarded with ultraviolet, fixing them to the chassis 2000. Alternatively, the OAE's 1604a-1604d can be soldered or welded to the chassis 2000 or fixed through some other method.

Returning to FIG. 20, the filter slots 2010a, 2010b, 2010c, and 2010d house the first 1606a, second 1606b, third 1606c, and fourth 1606d filters, respectively. The bores 2012a, 2012b, 2012c, and 2012d house the first 1602a, second 1602b, third 1602c, and fourth 1602d optical elements, respectively. For example, the collimated laser package 1700 or the detector package 1800 may be housed in one or more of the bores 2012a-2012d. The nozzle bore 2006, through hole 2008, bores 2010a-2010d, and filter slots 2012a-2012d allow the element 1608, optical elements 1602a-1602d, and filters 1606a-1606d, respectively, to be placed and fixed to the chassis 2000 without substantially compensating for optical alignment errors. Each OAE 1604a-1604d is placed within their respective pockets 2002a-2002d, and alignment for each beam path is attempted, as described above. Once aligned, the OAE's 1604a-1604d are fixed to the chassis 2000.

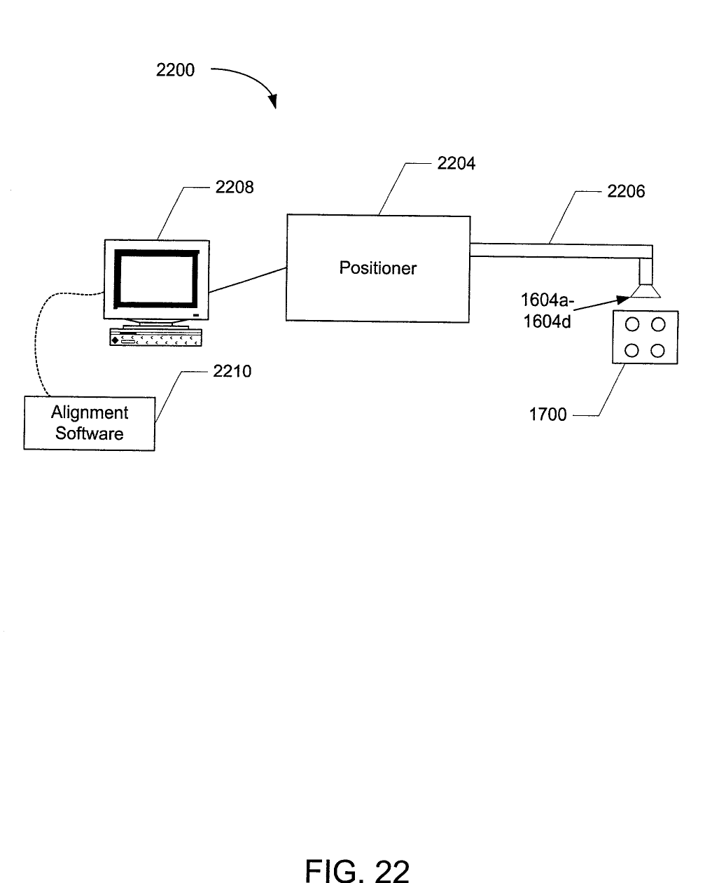

FIG. 22 illustrates an embodiment of a system for the method for aligning optical elements in accordance with the present invention. The system 2200 comprises a positioner 2204 with an arm 2206. The arm 2206 places each OAE 1604a-1604d into its respective pocket 2002a-2002d. The arm 2206 holds each OAE 1604a-1604d during alignment according to the method of the present invention. A computer 2208 comprising alignment software 2210 controls the positioner 2204. For example, the alignment software 2210 can implement the multi-axes alignment algorithm, as described above. The alignment software 2210 analyzes the power level of each beam at a location. It changes the placement and orientation of each OAE 1604a-1604d according to the alignment algorithm by sending commands to the positioner 2204. As each beam path is aligned, the OAE's 1604a-1604d are fixed to the chassis 2000.

An improved method for aligning optical elements has been disclosed. The method aligns optical elements by adjusting the placement and orientation of an optical alignment element (OAE) in a beam path. The adjustment of the beam path is able to substantially compensate for the cumulative alignment errors in the beam path. The method allows the optical elements in a device, other than the OAE, to be placed and fixed in place without substantially compensating for optical alignment errors. The OAE is inserted into the beam path and adjusted. This greatly increases the ease in the manufacturing of optical devices, especially for devices with numerous optical elements, and lowers the cost of manufacturing. Even as the number of optical elements in the device increases, alignment is still accomplished through the adjustment of the OAE. Because only the OAE needs to be accessed and moved for alignment, the size of the device can be smaller. Also, the tolerances of the placement of optical elements are increased, and the optical elements do not require special features for alignment.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for aligning a plurality of optical elements in an optical device, comprising the steps of:
(a) placing at least a first optical element in a first beam path;
(b) fixing the first optical element in place without substantially compensating for errors in optical alignment;
(c) placing at least a first optical alignment element (OAE) in the first beam path; and
(d) aligning the first beam path to a first desired beam path by adjusting the first OAE, wherein the alignment of the first beam path substantially compensates for cumulative alignment errors in the first beam path.

2. The method of claim 1, wherein the first OAE comprises two coupled, non-parallel, and non-co-planar surfaces, wherein at least one of the surfaces comprises a refractive or defractive element.

3. The method of claim 1, wherein the first OAE comprises two coupled, non-parallel, and non-co-planar surfaces, wherein each of the two of the coupled, non-parallel, and non-co-planar surfaces include a reflective element in the first beam path.

4. The method of claim 1, wherein the first optical element comprises one of the following:
a lens;
a mirror;
a collimator;
a laser;
a detector;
an optical fiber;
a fiber collimator;
a light emitting diode;
a holographic element;
an optical signal modulator;
a thermoelectrically cooled laser
a grating; and
an array of optical devices.

5. The method of claim 1, wherein the first optical element is a first filter.

6. The method of claim 4, wherein the first filter is a first reflective notch filter.

7. The method of claim 1, further comprising:
(a1) placing at least a second optical element in a second beam path;
(b1) fixing the second optical element in place without substantially compensating for errors in optical alignment;
(c1) placing at least a second OAE in the second beam path; and
(d1) aligning the second beam path to a second desired beam path by adjusting the second OAE, wherein the alignment of the second beam path substantially compensates for cumulative alignment errors in the second beam path.

8. The method of claim 7, wherein the second optical element comprises a second filter.

9. The method of claim 8, wherein the second filter is a second reflective notch filter.

10. The method of claim 7, further comprising:
(a2) placing at least a third optical element in a third beam path;
(b2) fixing the third optical element in place without substantially compensating for errors in optical alignment;
(c2) placing at least a third OAE in the third beam path; and
(d2) aligning the third beam path to a third desired beam path by adjusting the third OAE, wherein the alignment of the third beam path substantially compensates for cumulative alignment errors in the third beam path.

11. The method of claim 9, wherein the third optical element comprises a third filter.

12. The method of claim 11, wherein the third filter is a third reflective notch filter.

13. The method of claim 10, further comprising:
(a3) placing at least a fourth optical element in a fourth beam path;
(b3) fixing the fourth optical element in place without substantially compensating for errors in optical alignment;
(c3) placing at least a fourth OAE in the fourth beam path; and
(d3) aligning the fourth beam path to a fourth desired beam path by adjusting the fourth OAE, wherein the alignment of the fourth beam path substantially compensates for cumulative alignment errors in the fourth beam path.

14. The method of claim 13, wherein the fourth optical element comprises a fourth filter.

15. The method of claim 14, wherein the fourth filter is a fourth reflective notch filter.

16. The method of claim 1, wherein the adjusting step (d) comprises:
(d1) selecting values for a plurality of parameters;
(d2) adjusting a placement and an orientation of the first OAE in the first beam path along a plurality of axes;
(d3) determining a power level for the first beam path at a location; and
(d4) repeating steps (d2) and (d3) if the power level for the first beam path is not approximately a desired power level.

17. The method of claim 16, further comprising:
(d2i) adjusting a placement and an orientation of a second OAE in a second beam path along the plurality of axes;
(d3i) determining a power level for the second beam path at the location; and
(d4i) repeating steps (d2i) and (d3i) if the power level for the second beam path is not approximately a desired power level.

18. The method of claim 17, further comprising:
(d2ii) adjusting a placement and an orientation of a third OAE in a third beam path along the plurality of axes;
(d3ii) determining a power level for the third beam path at the location; and
(d4ii) repeating steps (d2ii) and (d3ii) if the power level for the third beam path is not approximately a desired power level.

19. The method of claim 18, further comprising:
(d2iii) adjusting a placement and an orientation of a fourth OAE in a fourth beam path along the plurality of axes;
(d3iii) determining a power level for the fourth beam path at the location; and
(d4iii) repeating steps (d2iii) and (d3iii) if the power level for the fourth beam path is not approximately a desired power level.

20. The method of claim 1, further comprising:
(e) fixing the first OAE in the first beam path in place.

21. The method of claim 20, wherein the fixing step (e) includes the use of epoxy.

22. The method of claim 20, wherein the fixing step (e) includes the use of welding.

23. The method of claim 20, wherein the fixing step (e) includes the use of soldering.

24. The method of claim 20, further comprising:
(e1) fixing a second OAE in a second beam path in place.

25. The method of claim 24, further comprising:
(e2) fixing a third OAE in a third beam path in place.

26. The method of claim 25, further comprising:
(e3) fixing a fourth OAE in a fourth beam path in place.

27. The method of claim 1, comprising:
placing a fifth optical element in the first beam path;
fixing the fifth optical element in place without substantially compensating for errors in optical alignment;
placing a sixth optical element in the first beam path; and
fixing the sixth optical element in place without substantially compensating for errors in optical alignment.

28. The method of claim 1, wherein:
the optical device includes a system conforming to an IEEE standard.

29. The method of claim 1, wherein:
the optical device includes a system conforming to an IEEE 802 standard.

30. The method of claim 1, wherein:
the optical device includes a system conforming to one or more of a XAUI, XENPAK and XGP transceiver standard.

31. A method for aligning a plurality of optical elements in an optical device, comprising the steps of:
(a) placing at least a first optical element in a first beam path and at least a second optical element in a second beam path;
(b) fixing the first optical element and the second optical element in place without substantially compensating for errors in optical alignment;
(c) placing at least a first OAE in the first beam path and at least a second OAE in the second beam path; and
(d) aligning the first beam path to a first desired beam path by adjusting the first OAE and aligning the second beam path to a second desire beam path by adjusting the second OAE, wherein the alignment of the first beam path substantially compensates for cumulative alignment errors in the first beam path, wherein the alignment of the second beam path substantially compensates for cumulative alignment errors in the second beam path.

32. The method of claim 31, wherein the first OAE comprises two coupled, non-parallel, and non-co-planar surfaces, wherein at least one of the surfaces comprises a refractive or defractive element.

33. The method of claim 31, wherein the first OAE comprises two coupled, non-parallel, and non-co-planar surfaces, wherein each of the two of the coupled, non-parallel, and non-co-planar surfaces include a reflective element in the first beam path.

34. The method of claim 31, wherein the second OAE comprises two coupled, non-parallel, and non-co-planar surfaces, wherein at least one of the surfaces comprises a refractive or defractive element.

35. The method of claim 31, wherein the first OAE comprises two coupled, non-parallel, and non-co-planar surfaces, wherein each of the two of the coupled, non-parallel, and non-co-planar surfaces include a reflective element in the first beam path.

36. The method of claim 31, wherein the first optical element comprises one of the following:
a lens;
a mirror;
a collimator;
a laser;
a detector;
an optical fiber;
a fiber collimator;
a light emitting diode;
a holographic element;
an optical signal modulator;
a thermoelectrically cooled laser
a grating; and
an array of optical devices.

37. The method of claim 31, wherein the second optical element comprises one of the following:
a lens;
a mirror;
a collimator;
a laser;
a detector;
an optical fiber;
a fiber collimator;
a light emitting diode;
a holographic element;
an optical signal modulator;
a thermoelectrically cooled laser
a grating; and
an array of optical devices.

38. The method of claim 31, wherein the first optical element is a first filter and the second optical element is a second filter.

39. The method of claim 38, wherein the first filter is a first reflective notch filter and the second filter a second reflective notch filter.

40. The method of claim 31, further comprising:
(a1) placing at least a third optical element in a third beam path;
(b1) fixing the third optical element in place without substantially compensating for errors in optical alignment;
(c1) placing at least a third OAE in the third beam path; and
(d1) aligning the third beam path to a third desired beam path by adjusting the third OAE, wherein the alignment of the third beam path substantially compensates for cumulative alignment errors in the third beam path.

41. The method of claim 40, wherein the third optical element comprises a third filter.

42. The method of claim 41, wherein the third filter is a third reflective notch filter.

43. The method of claim 40, further comprising:
(a2) placing at least a fourth optical element in a fourth beam path;
(b2) fixing the fourth optical element in place without substantially compensating for errors in optical alignment;
(c2) placing at least a fourth OAE in the fourth beam path; and
(d2) aligning the fourth beam path to a fourth desired beam path by adjusting the fourth OAE, wherein the alignment of the fourth beam path substantially compensates for cumulative alignment errors in the fourth beam path.

44. The method of claim 43, wherein the fourth optical element comprises a fourth filter.

45. The method of claim 44, wherein the fourth filter is a fourth reflective notch filter.

46. The method of claim 31, wherein the adjusting step (d) comprises:
(d1) selecting values for a plurality of parameters;
(d2) adjusting a placement and an orientation of the first OAE in the first beam path along a plurality of axes;
(d3) determining a power level for the first beam path at a location;
(d4) repeating steps (d2) and (d3) if the power level for the first beam path is not approximately a desired power level;
(d5) adjusting a placement and an orientation of a second OAE in a second beam path along the plurality of axes;
(d6) determining a power level for the second beam path at the location; and
(d7) repeating steps (d5) and (d6) if the power level for the second beam path is not approximately a desired power level.

47. The method of claim 39, further comprising:
(d2i) adjusting a placement and an orientation of a third OAE in a third beam path along the plurality of axes;
(d3i) determining a power level for the third beam path at the location; and
(d4i) repeating steps (d2i) and (d3i) if the power level for the third beam path is not approximately a desired power level.

48. The method of claim 47, further comprising:
(d2iii) adjusting a placement and an orientation of a fourth OAE in a fourth beam path along the plurality of axes;
(d3ii) determining a power level for the fourth beam path at the location; and
(d4ii) repeating steps (d2ii) and (d3ii) if the power level for the fourth beam path is not approximately a desired power level.

49. The method of claim 31, further comprising:
(e) fixing the first OAE in the first beam path in place; and
(f) fixing the second OAE in the second beam path in place.

50. The method of claim 49, wherein at least one of the fixing steps (e) and (f) includes epoxy.

51. The method of claim 49, wherein at least one of the fixing steps (e) and (f) includes welding.

52. The method of claim 49, wherein at least one of the fixing steps (e) and (f) includes soldering.

53. The method of claim 49, further comprising:
(e1) fixing a third OAE in a third beam path in place.

54. The method of claim 53, further comprising:
(e2) fixing a fourth OAE in a fourth beam path in place.

55. The method of claim 31, comprising:
placing a fifth optical element in the first beam path;
fixing the fifth optical element in place without substantially compensating for errors in at least one axis of optical alignment;
placing a sixth optical element in the first beam path; and
fixing the sixth optical element in place without substantially compensating for errors in at least one axis of optical alignment.

56. The method of claim 31, wherein:
the optical device includes a system conforming to an IEEE standard.

57. The method of claim 31, wherein:
the optical device includes a system conforming to an IEEE 802 standard.

58. The method of claim 31, wherein:
the optical device includes a system conforming to one or more of a XAUI, XENPAK and XGP transceiver standard.

59. A method for aligning a plurality of optical elements in an optical device, comprising the steps of:
(a) placing a plurality of optical elements in a plurality of beam paths;
(b) fixing the plurality of optical elements in place without substantially compensating for errors in alignment to a location;
(c) placing a plurality of OAE in the plurality of beam paths; and
(d) attempting to actively align the plurality of OAE to the location, wherein alignments of the plurality of OAE would substantially compensate for cumulative alignment errors in the plurality of beam paths.

60. The method of claim 59, wherein at least one of the plurality of OAE comprises two coupled, non-parallel, and non-co-planar surfaces, wherein one or more of the surfaces comprises a refractive or defractive element.

61. The method of claim 59, wherein at least one of the plurality of OAE comprises two coupled, non-parallel, and non-co-planar surfaces, wherein each of the two of the coupled, non-parallel, and non-co-planar surfaces include a reflective element.

62. The method of claim 59, wherein at least one of the plurality of optical elements comprises one of the following:
a lens;
a mirror;
a collimator;
a laser;
a detector;
an optical fiber;
a fiber collimator;
a light emitting diode;
a holographic element;
an optical signal modulator;
a thermoelectrically cooled laser
a grating; and
an array of optical devices.

63. The method of claim 59, wherein the placing step (a) comprises:
(a1) placing at least a first optical element in the first beam path and at least a second optical element in the second beam path;
(b1) fixing the first optical element and the second optical element in place without substantially compensating for errors in optical alignment;
(c1) placing at least a first OAE in the first beam path and at least a second OAE in the second beam path; and
(d1) aligning the first beam path to a first desired beam path by adjusting the first OAE and aligning the second beam path to a second desired beam path by adjusting the second OAE, wherein the alignment of the first beam path substantially compensates for alignment errors in the first beam path, wherein the alignment of the second beam path substantially compensates for alignment errors in the second beam path.

64. The method of claim 63, wherein the first optical element is a first filter and the second optical element is a second filter.

65. The method of claim 64, wherein the first filter is a first reflective notch filter and the second filter a second reflective notch filter.

66. The method of claim 63, further comprising:
(a2) placing at least a third optical element in a third beam path;
(b2) fixing the third optical element in place without substantially compensating for errors in optical alignment;
(c2) placing at least a third OAE in the third beam path; and
(d2) aligning the third beam path to a third desired beam path by adjusting the third OAE, wherein the alignment of the third beam path substantially compensates for cumulative alignment errors in the third beam path.

67. The method of claim 66, wherein the third optical element comprises a third filter.

68. The method of claim 67, wherein the third filter is a third reflective notch filter.

69. The method of claim 66, further comprising:
(a3) placing at least a fourth optical element in a fourth beam path;
(b3) fixing the fourth optical element in place without substantially compensating for errors in optical alignment;
(c3) placing at least a fourth OAE in the fourth beam path; and
(d3) aligning the fourth beam path to a fourth desired beam path by adjusting the fourth OAE, wherein the alignment of the fourth beam path substantially compensates for cumulative alignment errors in the fourth beam path.

70. The method of claim 69, wherein the fourth optical element comprises a fourth filter.

71. The method of claim 70, wherein the fourth filter is a fourth reflective notch filter.

72. The method of claim 59, wherein the adjusting step (d) comprises:
(d1) selecting values for a plurality of parameters;
(d2) adjusting a placement and an orientation of a first OAE in a first beam path along a plurality of axes;
(d3) determining a power level for the first beam path at a location;
(d4) repeating steps (d2) and (d3) if the power level for the first beam path is not approximately a desired power level;
(d5) adjusting a placement and an orientation of a second OAE in a second beam path along the plurality of axes;
(d6) determining a power level for the second beam path at the location; and
(d7) repeating steps (d5) and (d6) if the power level for the second beam path is not approximately a desired power level.

73. The method of claim 72, further comprising:
(d2i) adjusting a placement and an orientation of a third OAE in a third beam path along the plurality of axes;
(d3i) determining a power level for the third beam path at the location; and
(d4i) repeating steps (d2i) and (d3i) if the power level for the third beam path is not approximately a desired power level.

74. The method of claim 73, further comprising:
(d2ii) adjusting a placement and an orientation of a fourth OAE in a fourth beam path along the plurality of axes;
(d3ii) determining a power level for the fourth beam path at the location; and
(d4ii) repeating steps (d2ii) and (d3ii) if the power level for the fourth beam path is not approximately a desired power level.

75. The method of claim 59, further comprising:
(e) fixing a first OAE in a first beam path in place; and
(f) fixing a second OAE in a second beam path in place.

76. The method of claim 75, wherein at least one of the fixing steps (e) and (f) includes epoxying.

77. The method of claim 75, wherein at least one of the fixing steps (e) and (f) includes welding.

78. The method of claim 75, wherein at least one of the fixing steps (e) and (f) includes soldering.

79. The method of claim 75, further comprising:
(e1) fixing a third OAE in a third beam path in place.

80. The method of claim 79, further comprising:
(e2) fixing a fourth OAE in a fourth beam path in place.

81. The method of claim 59, wherein:
the optical device includes a system conforming to an IEEE standard.

82. The method of claim 59, wherein:
the optical device includes a system conforming to an IEEE 802 standard.

83. The method of claim 59, wherein:
the optical device includes a system conforming to one or more of a XAUI, XENPAK and XGP transceiver standard.

84. A method for aligning a plurality of optical elements in an optical device, comprising the steps of:
(a) placing at least a first optical element in a first beam path;
(b) fixing the first optical element in place without substantially compensating for errors in optical alignment; and
(d) step for aligning the first beam path to a first desired beam path, wherein the alignment of the first beam path substantially compensates for cumulative alignment errors in the first beam path.

85. The method of claim 84, wherein:
the optical device includes a system conforming to an IEEE standard.

86. The method of claim 84, wherein:
the optical device includes a system conforming to an IEEE 802 standard.

87. The method of claim 84, wherein:
the optical device includes a system conforming to one or more of a XAUI, XENPAK and XGP transceiver standard.
